(19) United States
(12) Patent Application Publication
(10) Pub. No.: US 2023/0174377 A1
(43) Pub. Date: Jun. 8, 2023

(54) PROCESS FOR THE PRODUCTION OF HYDROGEN

(71) Applicant: JOHNSON MATTHEY PUBLIC LIMITED COMPANY, London (GB)

(72) Inventors: William John COTTON, Billingham, Cleveland (GB); Mark Joseph MCKENNA, Billingham, Cleveland (GB); Majid SADEQZADEH BOROUJENI, Billingham, Cleveland (GB)

(21) Appl. No.: 17/998,103

(22) PCT Filed: Jun. 4, 2021
(86) PCT No.: PCT/GB2021/051395

§ 371 Date: Nov. 7, 2022

(30) Foreign Application Priority Data
Jun. 30, 2020 (GB) 2009970.1

(51) Int. Cl. C01B 3/38; C01B 3/48; C01B 3/50; C01B 3/52; C01B 3/56

(52) U.S. Cl. CPC C01B 3/382; C01B 3/48; C01B 3/506; C01B 3/52; C01B 3/56; C01B 2203/0233; C01B 2203/0244; C01B 2203/0288; C01B 2203/0822; C01B 2203/0894; C01B 2203/0883; C01B 2203/0495; C01B 2203/0475; C01B 2203/046; C01B 2203/0415; C01B 2203/042; C01B 2203/84; C01B 2203/062

(57) ABSTRACT

A process of hydrogen production comprising the steps of: subjecting a gaseous mixture comprising a hydrocarbon and steam, and having a steam to carbon ratio of at least 0.9:1, to adiabatic pre-reforming in a pre-reformer followed by autothermal reforming with an oxygen-rich gas in an autothermal reformer to generate a reformed gas mixture, optionally adding steam to the reformed gas mixture, increasing the hydrogen content of the reformed gas mixture by subjecting it to one or more water-gas shift stages in a water-gas shift unit to provide a hydrogen-enriched reformed gas, cooling the hydrogen-enriched reformed gas and separating condensed water therefrom, passing the resulting de-watered hydrogen-enriched reformed gas to a carbon dioxide separation unit to provide a carbon dioxide gas stream and a crude hydrogen gas stream, passing the crude hydrogen gas stream to a purification unit to provide a purified hydrogen gas and a fuel gas.

This invention relates to processes for the conversion of hydrocarbons to hydrogen whilst minimising carbon dioxide production.

Processes for generating hydrogen are well-known and generally include a fired steam methane reformer combined with water-gas shift and carbon dioxide (CO₂) removal. Such processes create significant volumes of carbon dioxide in flue gases at pressures unsuitable for efficient CO₂ capture. There is a need for hydrogen production processes that generate lower levels of carbon dioxide effluent and enable more efficient CO₂ capture.

WO2011077106 (A1) discloses a process for reducing the CO₂ emissions from a combined cycle power generation process utilizing a gaseous hydrocarbon feed, comprising splitting the hydrocarbon feed into two portions; a first smaller portion and a second larger portion comprising, feeding the first smaller portion to an autothermal reforming process to generate a hydrogen-containing gas and a carbon dioxide stream, combining the hydrogen-containing stream with the second portion of the gaseous hydrocarbon, combusting the resulting hydrogen-containing fuel stream with an oxygen containing gas in a gas turbine to generate electrical power and passing the exhaust gas mixture from the gas turbine to a heat recovery steam generation system that feeds one or more steam turbines to generate additional electrical power. The captured carbon dioxide stream may be fed to storage or enhanced oil recovery processes.

We have developed an improved process where the percentage of CO₂ captured may be 95% or higher.

Accordingly, the invention provides a process for the production of hydrogen comprising the steps of:
(i) subjecting a gaseous mixture comprising a hydrocarbon and steam, and having a steam to carbon ratio of at least 0.9:1, to adiabatic pre-reforming in a pre-reformer followed by autothermal reforming with an oxygen-rich gas in an autothermal reformer to generate a reformed gas mixture,
(ii) increasing the hydrogen content of the reformed gas mixture by subjecting it to one or more water-gas shift stages in a water-gas shift unit to provide a hydrogen-enriched reformed gas,
(iii) cooling the hydrogen-enriched reformed gas and separating condensed water therefrom to provide a de-watered hydrogen-enriched reformed gas,
(iv) passing the de-watered hydrogen-enriched reformed gas to a carbon dioxide separation unit to provide a carbon dioxide gas stream and a crude hydrogen gas stream, and
(v) passing the crude hydrogen gas stream from the carbon dioxide removal unit to a purification unit to provide a purified hydrogen gas and a fuel gas,
   wherein the fuel gas is fed to one or more fired heaters used to heat one or more process streams within the process.

By using a pre-reformer coupled to the autothermal reformer and operating at the selected steam to carbon ratio it is possible to use all the fuel gas for the one or more fired heaters and thereby minimise CO₂ emissions from the process. Further efficiency enhancements are also possible, thereby enabling 95% or higher CO₂ capture from the process.

The gaseous mixture may comprise any gaseous or low boiling hydrocarbon, such as natural gas, associated gas, LPG, petroleum distillate, diesel, naphtha or mixtures thereof, or hydrocarbon-containing off-gases from chemical processes, such as a refinery off-gas or a pre-reformed gas. The gaseous mixture preferably comprises methane, associated gas or natural gas containing a substantial proportion, e.g. over 50% v/v methane. Natural gas is especially preferred. The hydrocarbon may be compressed to a pressure in the range 10-100 bar abs. The pressure of the hydrocarbon may usefully govern the pressure throughout the process. Operating pressure is preferably in the range 15-50 bar abs, more preferably 25-50 bar abs as this provides an enhanced performance from the process.

Unlike WO2011077106 (A1) the hydrocarbon is not divided.

If the hydrocarbon contains sulphur compounds, before, or preferably after, compression it may be subjected to desulphurisation comprising hydrodesulphurisation using CoMo or NiMo catalysts, and absorption of hydrogen sulphide using a suitable hydrogen sulphide adsorbent, e.g. a zinc oxide adsorbent. An ultra-purification adsorbent may usefully be used downstream of the hydrogen sulphide adsorbent to further protect the steam reforming catalyst. Suitable, ultra-purification adsorbents may comprise copper-zinc oxide/alumina materials and copper-nickel-zinc oxide/alumina materials. To facilitate hydrodesulphurisation and/or reduce the risk of carbon laydown in the reforming process, hydrogen is preferably added to the compressed hydrocarbon. The amount of hydrogen in the resulting mixed gas stream may be in the range 1-20% vol, but is preferably in the range 1-10% vol, more preferably in the range 1-5% vol on a dry gas basis. In a preferred embodiment, a portion of the crude or purified hydrogen gas stream may be mixed with the compressed hydrocarbon. Hydrogen may be combined with the hydrocarbon upstream and/or downstream of any hydrodesulphurisation stage.

If the hydrocarbon contains other contaminants, such as chloride or heavy metal contaminants, these may be removed, prior to reforming, upstream or downstream of any desulphurisation, using conventional adsorbents. Adsorbents suitable for chloride removal are known and include alkalised alumina materials. Similarly, adsorbents for heavy metals such as mercury or arsenic are known and include copper sulphide materials

The hydrocarbon may be pre-heated in one or more stages. It may conveniently be pre-heated after compression and before desulphurisation. Various hot gas sources are provided in the present process that may be used for this duty. For example, the hydrocarbon feed stream may be heated in heat exchange with a shifted gas stream recovered from a water-gas shift stage, preferably a high-temperature shift stage. Where the hydrocarbon is desulphurised, after desulphurisation it may be further heated before being mixed with steam. The desulphurised hydrocarbon may, for example, be heated in a fired heater fuelled by the fuel gas.

The hydrocarbon is mixed with steam. The steam introduction may be performed by direct injection of steam and/or by saturation of the hydrocarbon by contact with a stream of heated water. In a preferred embodiment, the gaseous mixture comprising the hydrocarbon and steam is formed by directly mixing the hydrocarbon with steam, preferably steam generated in the one or more fired heaters and/or from cooling the reformed gas mixture with water. The amount of steam introduced is sufficient to give a steam to carbon ratio (defined as the steam to hydrocarbon carbon ratio at the inlet to reforming unit operations) of at least 0.9:1, i.e. at least 0.9 moles of steam per gram atom of hydrocarbon carbon in the gaseous mixture, with a preferred range of 0.9:1 to 3.5:1. Where the steam to carbon ratio at the inlet to the reforming unit operations is in the range 0.9:1 to less than 2.4:1, it will be necessary to add additional steam to the reformed gas upstream of the water-gas shift stage. Operating the reforming section at a steam to carbon ratio in the range of 0.9:1 to less than 2.4:1 has the advantage that the heating requirement and oxygen demand for the reforming stages is reduced and that the front-end equipment (e.g. fired heater, pre-reformer, and autothermal reformer) will be smaller and lower in cost. Where the steam to carbon ratio is in the range 2.4:1 to 3.5:1, no further steam addition upstream of the water-gas shift unit is necessary, which may be useful in circumstances where steam addition to the reformed gas is impractical.

Where pre-heating of the gaseous mixture comprising hydrocarbon and steam is performed using the one or more fired heaters, no further heating step is required prior to the adiabatic pre-reforming step.

The gaseous mixture comprising hydrocarbon and steam is subjected to a step of adiabatic steam reforming in a pre-reformer vessel followed by autothermal reforming in an autothermal reformer. The pre-reformer and autothermal reformer are operated in series.

In pre-reforming, the gaseous mixture comprising hydrocarbon and steam is passed at an inlet temperature in the range of 400-650° C., preferably 500-550° C., adiabatically through a bed of a steam reforming catalyst, usually a steam reforming catalyst having a high nickel content, for example above 40% by weight. During such an adiabatic pre-reforming step, any hydrocarbons higher than methane react with steam to give a mixture of methane, carbon oxides and hydrogen. The use of such an adiabatic steam reforming step, commonly termed pre-reforming, is desirable to ensure that the feed to the autothermal reformer contains no hydrocarbons higher than methane and also contains some hydrogen.

In the present invention the pre-reformed gas, which comprises methane, hydrogen, steam and carbon oxides, is fed to an autothermal reformer in which it is subjected to autothermal reforming. In the current process, all of the pre-reformed gas is fed to the autothermal reformer. If desired, the temperature and/or pressure of the pre-reformed gas may be adjusted before feeding it to the autothermal reformer. In a preferred embodiment, the pre-reformed gas mixture recovered from the adiabatic reforming step is heated before feeding it to the autothermal reformer by passing it through a fired heater fuelled by at least a portion of the fuel gas, in particular through the same fired heater used to pre-heat the hydrocarbon. Desirably, the pre-reformed gas is heated to 600-700° C., preferably 620-680° C.

The autothermal reformer may comprise a burner disposed at the top of the reformer, to which the steam reformed gas and the oxygen-rich gas are fed, a combustion zone beneath the burner through which a flame extends, and a fixed bed of particulate steam reforming catalyst disposed below the combustion zone. In autothermal reforming, the heat for the endothermic steam reforming reactions is therefore provided by combustion of a portion of hydrocarbon in the pre-reformed feed gas. The pre-reformed gas is typically fed to the top of the reformer and the oxygen-rich gas fed to the burner, mixing and combustion occur downstream of the burner generating a heated gas mixture the composition of which is brought to equilibrium as it passes through the steam reforming catalyst. The autothermal steam reforming catalyst may comprise nickel supported on a refractory support such as rings or pellets of calcium aluminate, magnesium aluminate, alumina, titania, zirconia and the like. In a preferred embodiment, the autothermal steam reforming catalyst comprises a layer of a catalyst comprising Ni and/or Ru on zirconia over a bed of a Ni on alumina catalyst to reduce catalyst support volatilisation that can result in deterioration in performance of the autothermal reformer.

The oxygen-rich gas may comprise at least 50% vol O₂ and may be an oxygen-enriched air mixture however in the present invention the oxygen-rich gas preferably comprises at least 90% vol 02, more preferably at least 95% vol O₂, most preferably at least 98% vol O₂, or at least 99% vol 02, e.g. a pure oxygen gas stream, which may be obtained using a vacuum pressure swing adsorption (VPSA) unit or an air separation unit (ASU). The ASU may be electrically driven and is desirably driven using renewable electricity to further improve the efficiency of the process and minimise CO₂ emissions.

The amount of oxygen-rich gas added is preferably such that 45 to 65 moles of oxygen are added per 100 moles of carbon in the hydrocarbon fed to the process. Preferably the amount of oxygen added is such that the autothermally reformed gas leaves the autothermal reforming catalyst at a temperature in the range 800-1100° C. In a preferred embodiment, a small purge of steam may be added to the oxygen-rich gas to protect against reverse flow if the plant trips.

After leaving the autothermal reformer, the reformed gas is then typically cooled in one or more steps of heat exchange. These may comprise at least a first stage of steam raising, for example using a boiler with connected steam drum. In one embodiment, at least a portion of the steam generated by cooling of the reformed gas, optionally following heating in the one or more fired heaters, is mixed with the hydrocarbon to form the gaseous mixture comprising hydrocarbon and steam. In another embodiment, the oxygen-rich gas fed to the autothermal reformer is heated before being fed to the autothermal reformer in heat exchange with steam generated by cooling of the reformed gas. For safety reasons the reformed gas is preferably not used to directly heat the oxygen-containing gas fed to the autothermal reformer. Whereas one or more additional cooling steps may be carried out, these are generally not required in the present process.

The reformed gas recovered from the autothermal reformer comprises hydrogen, carbon monoxide, carbon dioxide, steam, and a small amount of unreacted methane, and may also contain small amounts of inert gases such as nitrogen and argon. For example, in processes where all of the process steam is added upstream of the reforming unit operations, the hydrogen content of the autothermally-reformed gas may be in the range 35-45% vol and the CO content in the range 10-20% vol. In the current process, the hydrogen content of the reformed gas mixture is increased by subjecting it to one or more water-gas shift stages in a water-gas shift unit thereby producing a hydrogen-enriched reformed gas stream and at the same time converting carbon monoxide to carbon dioxide. The reaction may be depicted as follows;

CO+H₂O↔CO₂+H₂

Optionally, but particularly where the steam to carbon ratio of the gaseous mixture fed to the pre-reformer is below 2.4:1, additional process steam may be added to the reformed gas to improve the equilibrium position in the water-gas shift stage. Thus, in some embodiments the process includes optionally adding steam to the reformed gas. Steam may be added to the reformed gas upstream of the water-gas shift unit, for example upstream of a high-temperature shift stage. The amount of steam to be added will vary depending on the amount of steam in the gaseous mixture comprising hydrocarbon that is fed to the reforming stages. The amount of steam added is desirably commensurate with maximising carbon capture from the process, which is assisted by minimising carbon monoxide slip. Therefore, where steam is added to the reformed gas, the molar steam to dry gas ratio of the reformed gas is preferably at least 0.7:1, more preferably in the range of 0.7:1 to 0.9:1.

However, where the reforming is performed with an excess of steam it is generally not necessary to add steam to the reformed gas mixture recovered from the autothermal reformer.

Whereas the water-gas shift unit may comprise one shift stage employing a suitably stable and active shift catalyst, the reformed gas is preferably subjected to two or more water-gas shift stages comprising high-temperature shift, medium-temperature shift, isothermal shift and low-temperature shift. In this way the favourable equilibrium at low temperature may be used to maximise hydrogen formation, along with conversion of carbon monoxide to carbon dioxide. By using two or more shift stages, extremely low CO levels in the shifted gas are possible.

High-temperature shift is operated adiabatically in a shift vessel with inlet temperature in the range 300-400° C., preferably 320-360° C., over a bed of a reduced iron catalyst, such as chromia-promoted magnetite. Alternatively, a promoted zinc-aluminate catalyst may be used. Medium-temperature shift and low-temperature shift stages may be performed using shift vessels containing supported copper-catalysts, particularly copper/zinc oxide/alumina compositions. In low-temperature shift, a gas containing carbon monoxide (preferably ≤6% vol CO on a dry basis) and steam (at a steam to total dry gas molar ratio in range 0.3:1 to 1.5:1) may be passed over the catalyst in an adiabatic fixed bed with an outlet temperature in the range 200 to 300° C. Typically, the inlet gas is the product of “high-temperature shift” in which the carbon monoxide content has been decreased by reaction over an iron-chromia catalyst at an outlet temperature in the range 400 to 500° C., followed by cooling by indirect heat exchange. The outlet carbon monoxide content from the low-temperature water gas shift stage is typically in the range 0.1 to 1.0%, especially under 0.5% vol, on a dry basis. Alternatively, in medium-temperature shift, the gas containing carbon monoxide and steam is fed at a pressure in the range 15-50 bar abs to the catalyst at an inlet temperature typically in the range 200 to 240° C. although the inlet temperature may be as high as 280° C., and the outlet temperature is typically up to 300° C. but may be as high as 360° C.

A shift unit comprising a combination of high-temperature shift and low-temperature shift stages, each stage operated adiabatically, is preferred in the present process.

Adiabatic operation of the shift stages results in an increase in the temperature of the shifted gas mixtures and subsequent heat exchange with one or more process fluids is generally desirable. Where the shift unit comprises a high-temperature shift stage, two stages of heat exchange are preferable in which a hot shifted gas mixture may be cooled by heat exchange with water under pressure and with the hydrocarbon. In a preferred arrangement, a hot shifted gas from a high-temperature shift stage is cooled in a first stage of heat exchange with the hydrocarbon and in a second stage of heat exchange with water under pressure.

Whereas the low-temperature shift and medium-temperature shift reactions may be operated adiabatically it is also possible to operate them isothermally, i.e. with heat exchange in the shift vessel such that the reaction in the catalyst bed occurs in contact with heat exchange surfaces. The coolant conveniently may be water under pressure such that partial, or complete, boiling takes place. The resulting steam can be used, for example, to drive a turbine for power or to provide process steam for the water-gas shift or steam reforming reactions. The water can be in tubes surrounded by catalyst or vice versa. Whereas the term “isothermal” is used, there may be a small increase in temperature of the gas between inlet and outlet, so that the temperature of the hydrogen-enriched reformed gas stream at the exit of the isothermal shift converter may be between 1 and 25 degrees Celsius higher than the inlet temperature.

Following the one or more shift stages, the hydrogen-enriched reformed gas is cooled to a temperature below the dew point so that the steam condenses. The liquid water condensate may then be separated using one or more gas-liquid separators, which may have one or more further cooling stages between them. Any coolant may be used. Preferably, cooling of the hydrogen-enriched reformed gas stream is first carried out in heat exchange with water. In a preferred arrangement, the hydrogen-enriched reformed gas mixture is cooled in heat exchange with water and the resulting heated water fed to a steam drum coupled to the boiler used to cool the reformed gas mixture. One or more further stages of cooling are desirable. The cooling may be performed in heat exchange in one or more stages using demineralised water, air, or a combination of these.

Two or three stages of condensate separation are preferred. If desired, a portion or all of the condensate may be used to generate steam for the adiabatic pre-reforming step or may be used to generate steam added to the oxygen-rich gas fed to the autothermal reformer. In this way, organic compounds in the condensate may be returned to the process and so reduce the burden on any aqueous effluent treatment. Any condensate not used to generate steam may be sent to water treatment as effluent.

Typically, the hydrogen-enriched reformed gas stream contains 20 to 30% by volume of carbon dioxide (on a dry basis). In the present invention, after separation of the condensed water, carbon dioxide is separated from the resulting de-watered hydrogen-enriched reformed gas stream.

The carbon dioxide separation stage may be performed using a physical wash system or a reactive wash system, preferably a reactive wash system, especially an amine wash system. The carbon dioxide may be separated by an acid gas recovery (AGR) process. In the AGR process, the de-watered hydrogen-enriched reformed gas stream (i.e. the de-watered shifted gas) is contacted with a stream of a suitable absorbent liquid, such as an amine, particularly methyl diethanolamine (MDEA) solution so that the carbon dioxide is absorbed by the liquid to give a laden absorbent liquid and a gas stream having a decreased content of carbon dioxide. The laden absorbent liquid is then regenerated by heating and/or reducing the pressure, to desorb the carbon dioxide and to give a regenerated absorbent liquid, which is then recycled to the carbon dioxide absorption stage. Alternatively, methanol or a glycol may be used to capture the carbon dioxide in a similar manner as the amine. In a preferred arrangement, at least part of the heating to regenerate the absorbent liquid is performed using steam generated in the one or more fired heaters. If the carbon dioxide separation step is operated as a single pressure process, i.e. essentially the same pressure is employed in the absorption and regeneration steps, only a little recompression of the recycled carbon dioxide will be required.

The recovered carbon dioxide, e.g. from the AGR, may be compressed and used for the manufacture of chemicals, sent to storage or sequestration, used in enhanced oil recovery (EOR) processes or used in the production of other chemicals. Compression may be accomplished using an electrically driven compressor powered by renewable electricity. In cases where the CO₂ is to be compressed for storage, transportation or use in EOR processes, the CO₂ may be dried to prevent liquid water present in trace amounts, from condensing. For example, the CO₂ may be dried to a dew point ≤−10° C. by passing it through a bed of a suitable desiccant, such as a zeolite, or contacting it with a glycol in a glycol drying unit.

Upon the separation of the carbon dioxide, the process provides a crude hydrogen gas stream. The crude hydrogen stream may comprise 85-99% vol hydrogen, preferably 90-99% vol hydrogen, more preferably 95-99% vol hydrogen, with the balance comprising methane, carbon monoxide, carbon dioxide and inert gases. Whereas this hydrogen gas stream is pure enough for many duties, in the present invention, the crude hydrogen gas stream is passed to a purification unit to provide a purified hydrogen gas and a fuel gas, so that the fuel gas may be used in the process as an alternative to external fuel sources.

The purification unit may suitably comprise a membrane system, a temperature swing adsorption system, or a pressure swing adsorption system. Such systems are commercially available. The purification unit is preferably a pressure swing adsorption unit. Such units comprise regenerable porous adsorbent materials that selectively trap gases other than hydrogen and thereby purify it. The purification unit produces a pure hydrogen stream preferably with a purity greater than 99.5% vol, more preferably greater than 99.9% vol, which may be compressed and used in downstream power or heating process, for example, by using it as fuel in a gas turbine (GT) or by injection into a domestic or industrial networked gas piping system. The pure hydrogen may also be used in a downstream chemical synthesis process. Thus, the pure hydrogen stream may be used to produce ammonia by reaction with nitrogen in an ammonia synthesis unit. Alternatively, the pure hydrogen may be used with a carbon dioxide-containing gas to manufacture methanol in a methanol production unit. Alternatively, the pure hydrogen may be used with a carbon-monoxide containing gas to synthesise hydrocarbons in a Fischer-Tropsch production unit. Any known ammonia, methanol or Fischer-Tropsch production technology may be used. Alternatively, the hydrogen may be used to upgrade hydrocarbons, e.g. by hydro-treating or hydro-cracking hydrocarbons in a hydrocarbon refinery, or in any other process where pure hydrogen may be used. Compression may again be accomplished using an electrically driven compressor powered by renewable electricity.

A portion of the crude hydrogen or a portion of the pure hydrogen may be recycled to the hydrocarbon feed stream if desired for desulphurisation and to reduce the potential for carbon formation on the catalyst in the pre-reformer.

The purification unit desirably operates with continual separation of the fuel gas from the crude hydrogen stream. The fuel gas composition depends on the extent of the purification of the crude hydrogen stream. The fuel gas may comprise 80-90% vol hydrogen, with the balance comprising methane, carbon monoxide, carbon dioxide and inert gases. The methane content may be in the range 1-5% vol, preferably 2-5% vol. The carbon monoxide content may be in the range 2-10% vol, preferably 2-8% vol. The carbon dioxide content may be in the range 0-1.5% vol. There may also be traces of steam and nitrogen in the range 0-5% vol.

The combination of pre-reforming, autothermal reforming and water-gas shift, operated as described herein, provides sufficient fuel gas to heat the process streams used in the process without significant additional fuel during normal operation. The volume of supplemental fuel in the process is desirably kept to a minimum to maximise the CO₂ capture efficiency. The amount of the supplemental fuel, e.g. natural gas, fed to the one or more fired heaters along with the fuel gas is preferably less than 5% vol of the total fuel provided, more preferably less than 3% vol of the total fuel provided, most preferably less than 2% of the total fuel provided.

In some circumstances, such as during start-up of the process, it may be necessary to supplement the fuel gas with a hydrocarbon fuel temporarily, but this should not materially reduce the efficiency of the process, and during normal operation the fuel gas recovered from the purification unit will be the main source of fuel provided to the one or more fired heaters.

In some embodiments, a single fired heater fuelled at least in part by the fuel gas recovered from the purification is sufficient to heat the hydrocarbon, the reformed gas recovered from the pre-reforming stage upstream of the autothermal reforming stage, and water to generate at least part of the steam for the process.

Whereas all the process streams requiring heating may be heated in a single fired heater, in a preferred arrangement one fired heater is used for process gas streams containing hydrocarbon and/or hydrogen and another is used solely to boil water for steam generation. The latter may therefore also be described as a boiler. The fuel gas may therefore be divided between a first fired heater used to heat hydrocarbon- and/or hydrogen-containing streams and a second fired heater used to boil water to generate steam. Using two fired heaters in this way provides a number of distinct advantages; it allows for steam to be raised within the second fired heater and thereby used as part of the plant start-up; it allows steam to be generated in the second fired heater whilst the plant is being shut down and supplied to the plant during the shut-down process; it makes start-up easier as the first and second fired heaters can be operated independently and eliminates coils being heated in a no-flow regime; and separating the first fired heater allows nitrogen to be warmed up as part of the start-up procedure whilst the second fired heater is either being brought into service or is itself being started up. The fuel gas split to the first and second fired heaters may be in the ranges of 10-90% vol to 90-10% vol respectively but is preferably 60-80% vol to the first fired heater and 40-20% vol to the second fired heater.

Steam generated in the second fired heater may be used to heat the CO₂ absorbent liquid in the carbon dioxide separation unit. The second fired heater may also be used to superheat steam recovered from the steam drum coupled to a waste-heat boiler heated by the reformed gas. The waste-heat boiler preferably is also used to generate steam used to pre-heat the oxygen-rich gas and/or to provide process steam to be added upstream of the water-gas shift unit to maximise the conversion to hydrogen and carbon dioxide. A portion of the steam from the waste-heat boiler may also be passed to a steam expander to generate power.

The invention is illustrated by reference to the accompanying drawing in which:

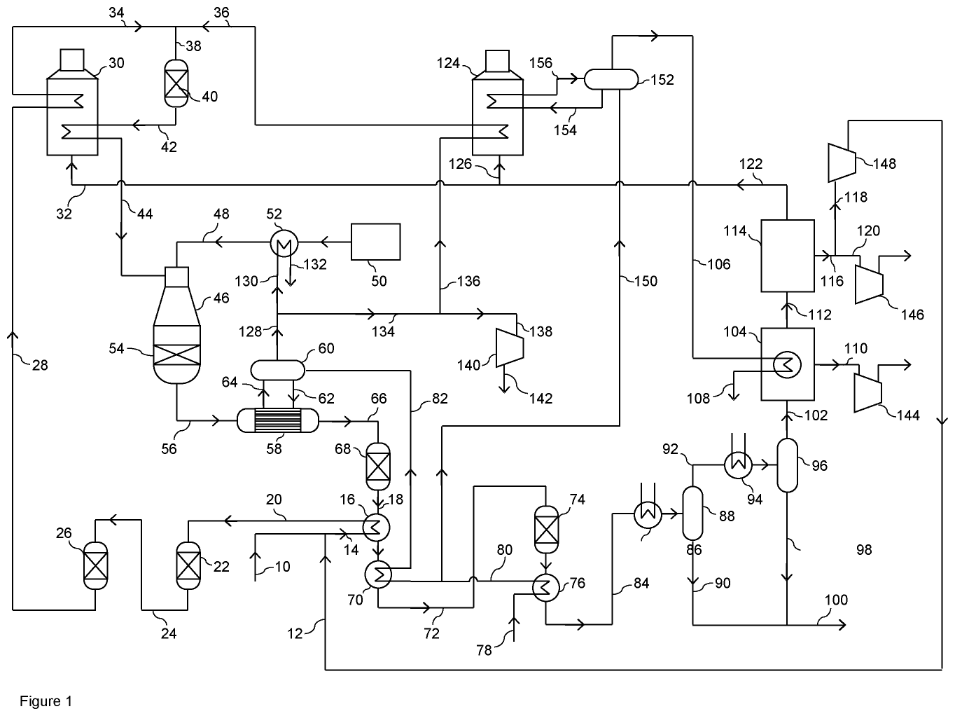

FIG. 1 is a diagrammatic flowsheet of one embodiment of the invention in which all of the process steam is added upstream of the reforming unit operations.

It will be understood by those skilled in the art that the drawings are diagrammatic and that further items of equipment such as reflux drums, pumps, vacuum pumps, temperature sensors, pressure sensors, pressure relief valves, control valves, flow controllers, level controllers, holding tanks, storage tanks, and the like may be required in a commercial plant. The provision of such ancillary items of equipment forms no part of the present invention and is in accordance with conventional chemical engineering practice.

In FIG. 1 a natural gas stream comprising >85% vol methane fed via line 10 is mixed with a hydrogen-containing stream 12 such that the resulting mixture contains between 1 and 5% vol hydrogen. The hydrogen-containing natural gas stream is fed via line 14 to a heat exchanger 16, where it is heated by a high-temperature shifted gas 18. The heated natural gas mixture is then desulphurised by passing it via line 20 to a hydrodesulphurisation (HDS) vessel 22 containing a bed of hydrodesulphurisation catalyst, where organic sulphur compounds are converted with the hydrogen to hydrogen sulphide, and then via line 24 to a vessel 26 containing a bed of zinc oxide adsorbent and a bed of a copper-zinc-alumina ultra-purification adsorbent that remove hydrogen sulphide.

The desulphurised natural gas is fed from the vessel 26 via line 28 to a first fired heater 30 where it is heated by combustion of a fuel gas fed to the heater via line 32. The heated natural gas is taken from the heater 30 via line 34 and combined with steam fed via line 36 to provide a natural gas and steam mixture having a steam to carbon ratio of about 2.5:1.

The natural gas and steam mixture is fed via line 38 to an adiabatic pre-reformer 40 containing a bed of pelleted nickel-based steam reforming catalyst. The higher hydrocarbons are converted to methane and partially steam reformed to produce a pre-reformed gas mixture containing hydrogen as the mixture passes over the pre-reforming catalyst. The pre-reformed gas mixture is then fed from the pre-reformer 40 via line 42 to the first fired heater 30 where it is heated to the autothermal reformer inlet temperature.

The heated pre-reformed gas mixture is fed from the fired heater 30 via line 44 to the burner region of an autothermal reformer 46, where it is partially combusted with oxygen fed via line 48 that has been produced in an air separation unit 50 and pre-heated in heat exchanger 52. The hot combusted gas mixture is brought towards equilibrium over a fixed bed of a pelleted nickel-based secondary reforming catalyst 54 disposed below the combustion zone in the autothermal reformer 46. The resulting hot reformed gas mixture is fed from the autothermal reformer 46 via line 56 to the tube-side of a steam-raising boiler 58 coupled to a steam drum 60. The hot reformed gas mixture boils water fed to the shell side of the boiler from the steam drum 60 via line 62 and returns steam from the boiler to the steam drum 60 via line 64. Steam drum 60 coupled to the boiler 58 generates high-pressure steam, which is recovered from the steam drum 60, divided, and used in the process. The hot reformed gas mixture is cooled as it passes through the boiler 58.

The resulting cooled reformed gas mixture is fed from the tube side of boiler 58 via line 66 to a first shift vessel 68 containing a fixed bed of particulate bed of iron-based high-temperature shift catalyst. The water-gas shift reaction whereby the hydrogen content of the reformed gas is increased, and the carbon monoxide converted to carbon dioxide occurs as the gas passes through the bed. The partially shifted reformed gas is fed from the first shift reactor via line 18 to the heat exchanger 16 where it pre-heats the natural gas, and then to a further heat exchanger 70 in which it is cooled with water under pressure. The cooled partially shifted gas mixture is fed from heat exchanger 70 via line 72 to a second shift vessel 74 containing a fixed bed of a particulate copper-based low-temperature shift catalyst. The water-gas shift reaction moves further to completion as the gas passes through the bed. The resulting hydrogen-enriched reformed gas mixture is then cooled in a heat exchanger 76, fed with cold pressurised demineralised deaerated water provided to the process via line 78. Part of the water recovered from heat exchanger 76 in line 80 is fed to the heat exchanger 70 used to cool the partially shifted gas mixture. The heated water recovered from the heat exchanger 70 is fed via line 82 to the steam drum 60 to provide coolant for the reformed gas mixture in the boiler 58.

The cooled hydrogen-enriched reformed gas is fed from the heat exchanger 76 via line 84 to a further heat exchanger 86, where it is further cooled with water. The cooling lowers the temperature of the gas mixture to below the dew point so that water condenses. The cooled stream is fed from the heat exchanger 86 to a gas-liquid separator 88 in which the condensate is separated from the hydrogen-enriched reformed gas mixture. The condensate is recovered from the separator 88 via a line 90. In this embodiment, a partially de-watered hydrogen-enriched reformed gas mixture is recovered from the separator 88 via line 92 and further cooled in heat exchange with water in heat exchanger 94. The cooled gas is passed to a second gas-liquid separator 96 to recover a further condensate stream 98. The condensate streams 90 and 98 are combined and sent for water treatment as effluent 100.

The de-watered hydrogen-enriched reformed gas mixture is fed from the separator 96 via line 102 to a CO₂ removal unit 104, such as an acid gas recovery unit, operating with a liquid absorbent wash system that absorbs CO₂ and any remaining H₂O from the gas. Absorbed CO₂ is recovered from the CO₂-laden absorbent liquid in the unit 104 by heating it using steam fed to the unit 104 via line 106 and reducing the pressure. Water recovered with the CO₂ is separated and sent for water treatment (not shown). Steam condensate is recovered from the CO₂ removal unit 104 via line 108. The recovered CO₂ from the CO₂ removal unit 104 is sent via line 110 for compression and storage.

A crude hydrogen gas stream is recovered from the CO₂ removal unit 104 and fed via line 112 to a pressure swing adsorption unit 114 containing a porous adsorbent that traps carbon oxides and methane in the crude hydrogen, thereby producing a purified hydrogen stream. The purified hydrogen gas is recovered from the pressure swing adsorption unit 114 via line 116. A portion of the purified hydrogen is taken via line 118 and compressed to form the recirculated hydrogen stream 12. The remaining purified hydrogen in line 120 is compressed and sent either for storage, for the generation of power or heat or for the production or conversion of chemicals.

The pressure swing adsorption unit 114, by adjusting the pressure, desorbs the carbon oxides and methane trapped in the porous adsorbent thereby generating a fuel gas. The fuel gas is recovered from the pressure swing adsorption unit 114 via line 122. A portion of the fuel gas in line 122 is provided to the first fired heater 30 via line 32 as the sole fuel to that heater. A second portion of the fuel gas in line 122 is provided as the sole fuel to a second fired heater 124 via line 126.

The second fired heater 124 raises steam for the process by the combustion of the fuel gas provided via line 126.

High-pressure steam is recovered from the steam drum 60 via line 128. A first portion, optionally after pressure reduction, is fed from line 128 via line 130 to heat the oxygen-rich gas in heat exchanger 52. Condensate is recovered from the heat exchanger 52 via line 132. A second portion is taken from the remaining high-pressure steam via lines 134 and 136 to the second fired heater 124 for further heating to produce superheated steam that is fed to the desulphurised natural gas stream 34 via line 36. A third portion is taken from the remaining high-pressure steam via line 138 to a steam turbine 140 to generate electrical power for the process, for example to drive the air separation unit 50 and/or electrically-driven compressors 144, 146 and 148.

A stream of hot water may be taken from the pre-heated demineralised water in line 80 as shown, or from the pre-heated demineralised water in line 82, and fed via line 150 to a steam drum 152 where the heated water is circulated via lines 154 and 156 through the second fired heater 124 to generate steam at low pressure. Steam from the steam drum 152 is recovered via line 106 and used to heat the CO₂ absorbent liquid in the CO₂ removal unit 104.

The efficient use of the fuel gas to provide the heated natural gas feed streams and steam for the process minimises CO₂ emissions from the process.

### EXAMPLE 1

The invention is further illustrated by the following calculated example of a process in accordance with the flowsheet depicted in FIG. 1.

| Stream Number | | 10 | 12 | 18 | 20 | 32 | 36 | 38 |
|---|---|---|---|---|---|---|---|---|
| Molar Flow | kNm³/h | 42.3 | 0.9 | 244.6 | 43.2 | 9.1 | 119.0 | 155.1 |
| Mass Flow | t/h | 32.4 | 0.1 | 158.8 | 32.5 | 2.1 | 90.1 | 122.6 |
| Temperature | ° C. | 40 | 70 | 454 | 380 | 40 | 450 | 540 |
| Pressure | bara | 41.3 | 43.5 | 36.6 | 40.8 | 1.5 | 40.8 | 40.0 |
| Molar Composition | | | | | | | | |
| Methane | mol % | 92.17 | 0.00 | 0.20 | 90.33 | 3.13 | 0.00 | 25.15 |
| Ethane | mol % | 6.32 | 0.00 | 0.00 | 6.19 | 0.00 | 0.00 | 1.72 |
| Propane | mol % | 0.52 | 0.00 | 0.00 | 0.51 | 0.00 | 0.00 | 0.14 |
| Butanes | mol % | 0.05 | 0.00 | 0.00 | 0.05 | 0.00 | 0.00 | 0.01 |
| Pentanes | mol % | 0.00 | 0.00 | 0.00 | 0.00 | 0.00 | 0.00 | 0.00 |
| Hydrogen | mol % | 0.00 | 100.00 | 48.27 | 1.99 | 85.97 | 0.00 | 0.56 |
| Carbon Dioxide | mol % | 0.15 | 0.00 | 15.13 | 0.15 | 0.82 | 0.00 | 0.10 |
| Carbon Monoxide | mol % | 0.00 | 0.00 | 3.17 | 0.00 | 5.09 | 0.00 | 0.00 |
| Oxygen | mol % | 0.00 | 0.00 | 0.00 | 0.00 | 0.00 | 0.00 | 0.00 |
| Nitrogen | mol % | 0.19 | 0.00 | 0.12 | 0.19 | 1.90 | 0.00 | 0.06 |
| Argon | mol % | 0.00 | 0.00 | 0.00 | 0.00 | 0.00 | 0.00 | 0.00 |
| Water | mol % | 0.61 | 0.00 | 33.10 | 0.59 | 2.95 | 100.00 | 72.13 |
| Methanol | mol % | 0.00 | 0.00 | 0.00 | 0.00 | 0.10 | 0.00 | 0.00 |
| Ammonia | mol % | 0.00 | 0.00 | 0.00 | 0.00 | 0.03 | 0.00 | 0.00 |

| Stream Number | | 42 | 44 | 48 | 56 | 66 | 72 | 78 |
|---|---|---|---|---|---|---|---|---|
| Molar Flow | kNm³/h | 162.8 | 162.8 | 25.4 | 244.6 | 244.6 | 244.6 | 199.1 |
| Mass Flow | t/h | 122.6 | 122.6 | 36.2 | 158.8 | 158.8 | 158.8 | 160.0 |
| Temperature | ° C. | 470 | 650 | 210 | 1020 | 360 | 205 | 120 |
| Pressure | bara | 39.8 | 39.5 | 40.0 | 37.5 | 37.0 | 35.6 | 43.0 |
| Molar Composition | | | | | | | | |
| Methane | mol % | 25.33 | 25.33 | 0.00 | 0.20 | 0.20 | 0.20 | 0.00 |
| Ethane | mol % | 0.00 | 0.00 | 0.00 | 0.00 | 0.00 | 0.00 | 0.00 |
| Propane | mol % | 0.00 | 0.00 | 0.00 | 0.00 | 0.00 | 0.00 | 0.00 |
| Butanes | mol % | 0.00 | 0.00 | 0.00 | 0.00 | 0.00 | 0.00 | 0.00 |
| Pentanes | mol % | 0.00 | 0.00 | 0.00 | 0.00 | 0.00 | 0.00 | 0.00 |
| Hydrogen | mol % | 8.02 | 8.02 | 0.00 | 39.76 | 39.76 | 48.27 | 0.00 |
| Carbon Dioxide | mol % | 2.42 | 2.42 | 0.00 | 6.70 | 6.70 | 15.13 | 0.00 |
| Carbon Monoxide | mol % | 0.05 | 0.05 | 0.00 | 11.61 | 11.61 | 3.17 | 0.00 |
| Oxygen | mol % | 0.00 | 0.00 | 99.50 | 0.00 | 0.00 | 0.00 | 0.00 |
| Nitrogen | mol % | 0.05 | 0.05 | 0.50 | 0.09 | 0.09 | 0.12 | 0.00 |
| Argon | mol % | 0.00 | 0.00 | 0.00 | 0.00 | 0.00 | 0.00 | 0.00 |
| Water | mol % | 64.01 | 64.01 | 0.00 | 41.56 | 41.56 | 33.10 | 100.00 |
| Methanol | mol % | 0.00 | 0.00 | 0.00 | 0.00 | 0.00 | 0.00 | 0.00 |
| Ammonia | mol % | 0.00 | 0.00 | 0.00 | 0.00 | 0.00 | 0.00 | 0.00 |

| Stream Number | | 80 | 82 | 84 | 100 | 102 | 106 | 108 |
|---|---|---|---|---|---|---|---|---|
| Molar Flow | kNm³/h | 199.1 | 183.4 | 244.6 | 72.3 | 172.3 | 15.6 | 15.6 |
| Mass Flow | t/h | 160.0 | 147.4 | 158.8 | 58.2 | 100.6 | 12.6 | 12.6 |
| Temperature | ° C. | 135 | 230 | 212 | 114 | 71 | 157 | 154 |
| Pressure | bara | 42.5 | 42.0 | 34.6 | 33.6 | 33.6 | 5.8 | 5.3 |
| Molar Composition | | | | | | | | |
| Methane | mol % | 0.00 | 0.00 | 0.20 | 0.00 | 0.29 | 0.00 | 0.00 |
| Ethane | mol % | 0.00 | 0.00 | 0.00 | 0.00 | 0.00 | 0.00 | 0.00 |
| Propane | mol % | 0.00 | 0.00 | 0.00 | 0.00 | 0.00 | 0.00 | 0.00 |
| Butanes | mol % | 0.00 | 0.00 | 0.00 | 0.00 | 0.00 | 0.00 | 0.00 |
| Pentanes | mol % | 0.00 | 0.00 | 0.00 | 0.00 | 0.00 | 0.00 | 0.00 |
| Hydrogen | mol % | 0.00 | 0.00 | 51.08 | 0.00 | 72.50 | 0.00 | 0.00 |
| Carbon Dioxide | mol % | 0.00 | 0.00 | 17.95 | 0.11 | 25.44 | 0.00 | 0.00 |
| Carbon Monoxide | mol % | 0.00 | 0.00 | 0.33 | 0.00 | 0.47 | 0.00 | 0.00 |
| Oxygen | mol % | 0.00 | 0.00 | 0.00 | 0.00 | 0.00 | 0.00 | 0.00 |
| Nitrogen | mol % | 0.00 | 0.00 | 0.12 | 0.00 | 0.18 | 0.00 | 0.00 |
| Argon | mol % | 0.00 | 0.00 | 0.00 | 0.00 | 0.00 | 0.00 | 0.00 |
| Water | mol % | 100.00 | 100.00 | 30.28 | 99.85 | 1.11 | 100.00 | 100.00 |
| Methanol | mol % | 0.00 | 0.00 | 0.02 | 0.03 | 0.01 | 0.00 | 0.00 |
| Ammonia | mol % | 0.00 | 0.00 | 0.00 | 0.01 | 0.00 | 0.00 | 0.00 |

| Stream Number | | 110 | 112 | 116 | 120 | 122 | 126 | 128 |
|---|---|---|---|---|---|---|---|---|
| Molar Flow | kNm³/h | 43.7 | 127.2 | 111.2 | 110.3 | 16.0 | 6.9 | 181.8 |
| Mass Flow | t/h | 85.8 | 13.7 | 10.0 | 9.9 | 3.7 | 1.6 | 146.2 |
| Temperature | ° C. | 40 | 50 | 40 | 40 | 40 | 40 | 253 |
| Pressure | bara | 1.5 | 33.6 | 33.1 | 33.1 | 1.5 | 1.5 | 42.0 |
| Molar Composition | | | | | | | | |
| Methane | mol % | 0.00 | 0.39 | 0.00 | 0.00 | 3.13 | 3.13 | 0.00 |
| Ethane | mol % | 0.00 | 0.00 | 0.00 | 0.00 | 0.00 | 0.00 | 0.00 |
| Propane | mol % | 0.00 | 0.00 | 0.00 | 0.00 | 0.00 | 0.00 | 0.00 |
| Butanes | mol % | 0.00 | 0.00 | 0.00 | 0.00 | 0.00 | 0.00 | 0.00 |
| Pentanes | mol % | 0.00 | 0.00 | 0.00 | 0.00 | 0.00 | 0.00 | 0.00 |
| Hydrogen | mol % | 0.00 | 98.24 | 100.00 | 100.00 | 85.97 | 85.97 | 0.00 |
| Carbon Dioxide | mol % | 100.00 | 0.10 | 0.00 | 0.00 | 0.82 | 0.82 | 0.00 |
| Carbon Monoxide | mol % | 0.00 | 0.64 | 0.00 | 0.00 | 5.09 | 5.09 | 0.00 |
| Oxygen | mol % | 0.00 | 0.00 | 0.00 | 0.00 | 0.00 | 0.00 | 0.00 |
| Nitrogen | mol % | 0.00 | 0.24 | 0.00 | 0.00 | 1.90 | 1.90 | 0.00 |
| Argon | mol % | 0.00 | 0.00 | 0.00 | 0.00 | 0.00 | 0.00 | 0.00 |
| Water | mol % | 0.00 | 0.37 | 0.00 | 0.00 | 2.95 | 2.95 | 100.00 |
| Methanol | mol % | 0.00 | 0.01 | 0.00 | 0.00 | 0.10 | 0.10 | 0.00 |
| Ammonia | mol % | 0.00 | 0.00 | 0.00 | 0.00 | 0.03 | 0.03 | 0.00 |

| Stream Number | | 130 | 132 | 138 | 142 | 150 |
|---|---|---|---|---|---|---|
| Molar Flow | kNm³/h | 4.6 | 4.6 | 65.2 | 65.2 | 15.6 |
| Mass Flow | t/h | 3.7 | 3.7 | 52.4 | 52.4 | 12.6 |
| Temperature | ° C. | 253 | 253 | 253 | 69 | 135 |
| Pressure | bara | 42.0 | 41.5 | 42.0 | 0.3 | 42.5 |
| Molar Composition | | | | | | |
| Methane | mol % | 0.00 | 0.00 | 0.00 | 0.00 | 0.00 |
| Ethane | mol % | 0.00 | 0.00 | 0.00 | 0.00 | 0.00 |
| Propane | mol % | 0.00 | 0.00 | 0.00 | 0.00 | 0.00 |
| Butanes | mol % | 0.00 | 0.00 | 0.00 | 0.00 | 0.00 |
| Pentanes | mol % | 0.00 | 0.00 | 0.00 | 0.00 | 0.00 |
| Hydrogen | mol % | 0.00 | 0.00 | 0.00 | 0.00 | 0.00 |
| Carbon Dioxide | mol % | 0.00 | 0.00 | 0.00 | 0.00 | 0.00 |
| Carbon Monoxide | mol % | 0.00 | 0.00 | 0.00 | 0.00 | 0.00 |
| Oxygen | mol % | 0.00 | 0.00 | 0.00 | 0.00 | 0.00 |
| Nitrogen | mol % | 0.00 | 0.00 | 0.00 | 0.00 | 0.00 |
| Argon | mol % | 0.00 | 0.00 | 0.00 | 0.00 | 0.00 |
| Water | mol % | 100.00 | 100.00 | 100.00 | 100.00 | 100.00 |
| Methanol | mol % | 0.00 | 0.00 | 0.00 | 0.00 | 0.00 |
| Ammonia | mol % | 0.00 | 0.00 | 0.00 | 0.00 | 0.00 |

The flowsheet allows for capture of 95% of CO₂ at a steam to carbon ratio of 2.5:1.

### EXAMPLE 2

The invention is further illustrated by the following calculated example of a process in accordance with the flowsheet depicted in FIG. 1 with the following changes:
a) The operating pressure of the reforming unit operations is reduced to 26 barg;
b) The steam to carbon ratio in the gaseous mixture comprising natural gas and steam fed to the pre-reformer 40 is 0.95:1;
c) Oxygen is added to the autothermal reformer to achieve an exit temperature of 1065° C.;
d) Steam raised in the steam-raising boiler 58 is added to the cooled reformed gas 66 such that the feed at the inlet to the high-temperature water-gas shift has a steam to dry gas ratio of 0.72:1;
e) The product gas from the high-temperature water-gas shift reactor 68 is cooled such that the feed gas to the low-temperature water-gas shift reactor 74 has an inlet temperature of 190° C.; and
f) The balance of the fired heater duties in the two fired heaters 30 and 124 is adjusted to provide the apportioning of the process steam addition to both upstream and downstream of the reforming unit operations.

The flowsheet in this arrangement also allows for capture of 95% of CO₂ at a steam to carbon ratio of 0.95:1, which reduces the heat demand and oxygen consumption in the autothermal reformer.

1-27. (canceled)

28. A process for the production of hydrogen comprising the steps of:
(i) subjecting a gaseous mixture comprising a hydrocarbon and steam, and having a steam to carbon ratio of at least 0.9:1 to adiabatic pre-reforming in a pre-reformer followed by autothermal reforming with an oxygen-rich gas in an autothermal reformer to generate a reformed gas mixture,
(ii) increasing the hydrogen content of the reformed gas mixture by subjecting it to one or more water-gas shift stages in a water-gas shift unit to provide a hydrogen-enriched reformed gas,
(iii) cooling the hydrogen-enriched reformed gas and separating condensed water therefrom to provide a de-watered hydrogen-enriched reformed gas,
(iv) passing the de-watered hydrogen-enriched reformed gas to a carbon dioxide separation unit to provide a carbon dioxide gas stream and a crude hydrogen gas stream, and
(v) passing the crude hydrogen gas stream from the carbon dioxide removal unit to a purification unit to provide a purified hydrogen gas and a fuel gas,
wherein the fuel gas is fed to one or more fired heaters used to heat one or more process streams within the process.

29. The process according to claim 28, wherein the hydrocarbon is a methane-containing gas stream, preferably containing >50% vol of methane.

30. The process according to claim 28, wherein the hydrocarbon is desulphurised.

31. The process according to claim 28, wherein the steam to carbon ratio is in the range 0.9:1 to 3.5:1.

32. The process according to claim 28, wherein the steam to carbon ratio is in the range 0.9:1 to below 2.4:1, and the process includes adding steam to the reformed gas mixture.

33. The process according to claim 28, wherein the gaseous mixture comprising the hydrocarbon and steam is formed by mixing the hydrocarbon with steam generated by the one or more fired heaters and/or by cooling the reformed gas mixture with water.

34. The process according to claim 28, wherein the oxygen-rich gas comprises at least 90% vol O₂, preferably at least 95% vol O₂, more preferably at least 98% vol O₂.

35. The process according to claim 28, wherein the oxygen-rich gas is heated before being fed to the autothermal reformer in heat exchange with steam generated by cooling of the reformed gas.

36. The process according to claim 28, wherein the water-gas shift stage comprises a high-temperature shift stage and a downstream low-temperature shift stage.

37. The process according to claim 36, wherein the hydrocarbon is heated in heat exchange with a shifted gas stream recovered from the high-temperature shift stage.

38. The process according to claim 28, wherein steam generated in the one or more fired heaters is used to generate electrical power for the process.

39. The process according to claim 28, wherein there are at least two stages of cooling and separation of process condensate before the carbon dioxide removal stage.

40. The process according to claim 28, wherein the carbon dioxide removal stage is performed using a physical wash system or a reactive wash system, preferably a reactive wash system, especially an amine wash system.

41. The process according to claim 28, wherein one or more of the carbon dioxide removal unit streams are heated in heat exchange with steam generated in the one or more fired heaters.

42. The process according to claim 28, wherein the purification unit is a pressure swing adsorption unit or a temperature swing adsorption unit, preferably a pressure swing adsorption unit.

43. The process according to claim 28, wherein the carbon dioxide recovered from the carbon dioxide removal unit and the purified hydrogen gas recovered from the purification unit are each compressed in electrically-driven compressors.

44. The process according to claim 28, wherein a portion of the crude hydrogen or purified hydrogen is fed to the hydrocarbon.

45. The process according to claim 28, wherein a supplemental fuel is added to the fuel gas fed to the one or more fired heaters and the amount of the supplemental fuel is less than 5% vol, preferably less than 3% vol, more preferably less than 2% of the total fuel provided.

46. The process according to claim 28, wherein there is a single fired heated fuelled at least in part by the fuel gas recovered from the purification unit and the single fired heater is used to heat the hydrocarbon, the reformed gas recovered from the pre-reforming stage upstream of the autothermal reforming stage, and water to generate at least part of the steam for the process.

47. The process according to claim 28, wherein there are two fired heaters fuelled at least in part by the fuel gas recovered from the purification unit; a first fired heater that heats the hydrocarbon feed stream and a reformed gas stream recovered from the pre-reforming stage upstream of the autothermal reforming stage, and a second fired heater that functions as a boiler to generate steam for the process.

48. The process according to claim 47 wherein the fuel gas split to the first and second fired heaters in the ranges of 10-90% vol to 90-10% vol respectively, preferably 60-80% vol to the first fired heater and 40-20% vol to the second fired heater.

49. The process according to claim 47, wherein a portion of the steam generated in the second fired heater is used to heat a CO₂ absorbent liquid in the carbon dioxide separation unit.

50. The process according to claim 47, wherein steam generated in the second fired heater is used to superheat steam recovered from a steam drum coupled to a waste-heat boiler heated by the reformed gas.

51. The process according to claim 50, wherein the waste-heat boiler is also used to generate steam used to pre-heat the oxygen-rich gas.

52. The process according to claim 50, wherein a portion of the steam from the waste-heat boiler is passed to a steam expander to generate power.

53. The process according to claim 50, wherein when the steam to carbon ratio is below 2.4:1, a portion of the steam from the waste-heat boiler is added to the reformed gas.

54. The process according to claim 28, wherein the pure hydrogen stream is used in a downstream power process, heating process, a downstream chemical synthesis process or used to upgrade hydrocarbons.
